(19) United States
(12) Patent Application Publication
(10) Pub. No.: US 2015/0223493 A1
(43) Pub. Date: Aug. 13, 2015

(54) SYSTEM FOR AND METHOD OF CONVERTING AGRICULTURAL WASTE TO ANIMAL FEED AND OTHER VALUABLE RAW MATERIALS

(71) Applicant: Lee Tech LLC, Fremont, CA (US)

(72) Inventor: Chie Ying Lee, Fremont, CA (US)

(73) Assignee: Lee Tech LLC, Fremont, CA (US)

(21) Appl. No.: 14/265,301

(22) Filed: Apr. 29, 2014

Related U.S. Application Data
(60) Provisional application No. 61/937,995, filed on Feb. 10, 2014.

(51) Int. Cl. A23K 1/14; B02C 23/08

(52) U.S. Cl. CPC A23K 1/146; B02C 23/08

(57) ABSTRACT

Methods of and devices for extracting nutrients (such as, proteins, oils, hydrocarbons, antioxidants, organic antibiotics, minerals, and vitamins) from discarded plant wastes (roots, skins, seeds, stalks, leaves, and stems) using grinding and separation processes are provided.

### CROSS-REFERENCE TO RELATED APPLICATION(S)

This application claims priority under 35 U.S.C. §119(e) of the U.S. Provisional Patent Application Ser. No. 61/937,995, filed Feb. 10, 2014 and titled, “A SYSTEM FOR AND METHOD FOR CONVERTING AGRICULTURAL WASTE TO ANIMAL FEED AND OTHER VALUABLE RAW MATERIALS,” which is hereby incorporated by reference in its entirety for all purposes.

### FIELD OF THE INVENTION

The present invention relates to the field of animal feed. More specifically, the present invention relates to system for and method of extracting and processing plant waste into animal feeds.

### BACKGROUND OF THE INVENTION

The world's population continues to rapidly increase creating dire food shortages due to the limited land on earth. This can be attributed to the tendency of consuming more animal protein than plant protein. It takes several pounds of plant protein to produce one pound of animal protein. For example, it takes an average of 8 pounds of plant protein to feed a cow to produce one pound of cow protein, 4 pounds of plant protein to feed a pig to produce one pound of pig protein, 3 pounds of plant protein to feed a chicken to produce one pound of chicken protein, and 1.5 pounds of plant protein feed fish to produce one pound of fish protein.

The plant wastes are from various sources. For example, many agricultural wastes are produced by all agricultural crops during the harvest. These include a) grain crops (such as rice, wheat, and corn, which have (1) stalks and straws and (2) hull and cobs); b) vine and leaf crops (such as peas and soybeans, which have (1) vines and leaves and (2) pods); and c) root crops (such as cassava and potato, which have (1) vines and leaves and 2) tubes. The crop waste in the field contains several times of weight compared to the actual crop produce and has low protein content (3 to 12% protein) with less nutrient value. As a result, it has very limited use as animal feed (mainly for cows and horses). It is normally turned over into ground as soil conditioner and fertilizer. Recycling agricultural waste is a sustainable manner, which avoids current burning methods that create unhealthy air pollution.

Further, many food process plants also produce waste during the food processing steps, such as rice/wheat bran, vegetables that cannot be used for human consumption, cassava/potato skins, and orange peels from orange juice plants. These wastes consist of about 5% to 10% of crops used by human and contain higher protein and valuable nutrients which can be used as part of animal feed.

Furthermore, farmers invest their time, energy, and resources to grow crops that are sold on the open market for supermarket distribution or further processing. When produce is harvested, the roots, shells, branches, leaves, or stems are cut. Texture and flavor properties of these remnant parts are deemed undesirable for human consumption and ultimately discarded. Recognizing that plant waste contains minerals such as nitrogen, potassium, and calcium which are vital for the soil to grow a new batch of crops, farmers use their plant waste as fertilizer. Some of the plant wastes containing higher level of vitamins, mineral and protein that are used as part of animal feed have existed and remained for hundreds of years in the area with the lack of animal feed resource.

These agricultural wastes can be valuable for human and animal consumption. The proteins, hydrocarbon, oils, antibiotics, minerals, and antioxidants total content weight in this agricultural waste is more than those in crops that are consumed by human and animal. The majority of those valued resources; however, are not wholly used by human and animal because the low percentage level protein content with a very high cellulose content, which is not suitable for human and animal consumption. In fact, the discarded outer layer or shell of plant waste often possesses more nutrients than the inner body sold as produce.

### SUMMARY OF THE INVENTION

The present invention is able to extract nutrients (proteins, oils, hydrocarbons, antioxidants, organic antibiotics, minerals, and vitamins) from discarded plant waste (roots, skins, seeds, stalks, leaves, and stems) using grinding and separation processes in accordance with some embodiments of the present invention. The system of the present invention is able to run at steady production state and extract valuable materials from the plant waste for making animal feeds, including cellulosic materials for compost, organic fertilizer, raw materials for the paper industry, and alcohol production. All the plants/plant wastes described in the present specification are able to be used as a source of the raw material.

In some embodiments, the extraction method of the present invention uses a variety of materials including edible agricultural products, byproducts and wastes of agricultural products and plant inedible wastes. The method breaks the cell walls of the materials and releases valuable ingredients, such as protein, oil, hydrocarbon, organic antibiotics, vitamins, minerals and antioxidants. Next, separation steps are performed to separate the cellulosic material in a solid form from valuable animal nitrite compounds in a liquid slurry form. The liquid slurry with valuable compounds is further separated into protein, oil, starch, antioxidant, inorganic components (which are able to be used as animal feed) and mineral (which is able to be used as fertilize). The vitamins and other valuable chemicals are able to be optionally separated.

In an aspect, a method of making animal feed comprises collecting an agriculture substance, breaking cell walls of the agriculture substance, removing a cellulose substance, and forming food having a content suitable for animal consumption. In some embodiments, the method further comprises recovering oil. In other embodiments, the method further comprises coagulating protein. In some other embodiments, the coagulating protein comprises heating to a temperature higher than 160° F. In some embodiments, the coagulating protein comprises adjusting a pH value to be in the range between 3-6. In some other embodiments, the agriculture substance comprises a plant waste. In some embodiments, the plant waste comprises roots, skins, seed, stalks, leaves, or a combination thereof. In other embodiments, the method further comprises making a slurry by adding water to the agriculture substance. In some other embodiments, the slurry has a moisture content of 70%-90%. In some embodiments, the method further comprises releasing protein, oil, starch, antioxident, nutrient, or a combination thereof by the breaking cell walls. In other embodiments, the breaking cell walls is performed by using a milling device. In some other embodiments, the milling device comprises a hammer mill, a disc mill, a pin mill, a disintegrator, a simple blender type mill, or a combination thereof. In some embodiments, the removing a cellulose substance comprises using a cellulose washing or removing device, wherein the cellulose washing or removing device comprises a paddle screen, a vibration screen, a screen centrifuge, a screw press, or a combination thereof. In other embodiments, the method further comprises increasing a yield of protein recovery by using a solid/liquid separation device, wherein the solid/liquid separation device comprises a plate and frame filter, a drum filter, a solid/liquid centrifuge separator, a belt press, or a screw press. In some other embodiments, the method further comprises adding an enzyme or chemical at the breaking cell walls. In other embodiments, the food comprises protein, hydrocarbon, antioxidant, organic antibiotic, mineral, and vitamin. In some other embodiments, the method further comprises forming animal drinking water containing minerals and substantially free of protein. In some embodiments, the cellulose substance is treated to produce a raw material for paper industry, alcohol, animal bedding, compose, organic fertilizer, or organic packing material.

In another aspect, a system for agriculture waster converting comprises a cell wall breaking device, a cellulose separating device, an oil recovering device configured to recover oil released at the cell wall breaking device, a protein coagulating device, and a protein recovering device configured to recover an coagulated protein at the protein coagulating device. In some embodiments, the cell wall breaking device comprises a hammer mill, a disc mill, a pin mill, a disintegrator, a simple blender type mill, or a combination thereof. In other embodiments, the system further comprises a separation device. In some other embodiments, the separation device comprises a pressure screen, a paddle screen, a vibration screen, a screen centrifuge, a press, or a combination thereof.

In another aspect, a method of converting agriculture waste comprises gathering an amount of agriculture waste, breaking cell walls of the agriculture waste in a slurry using a milling device, such that proteins, hydrocarbons, antioxidants, organic antibiotics, minerals, and vitamins are released, removing cellulose from the slurry using a screen separating device, coagulating the proteins, and forming an animal food. In some embodiments, the method further comprises mixing an amount of water with the agriculture waste to form the slurry

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a system for converting agriculture waste in accordance with some embodiments of the present invention.

FIG. 2 illustrates a method of converting plant waste into useful animal feed in accordance with some embodiments of the present invention.

FIG. 3 illustrates a method of converting agriculture wastes to animal feed in accordance with some embodiments of the present invention.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals are vary from one implementation to another and from one developer to another. Moreover, it is appreciated that such a development effort can be complex and time-consuming, but is nevertheless a routine undertaking of engineering for those of ordinary skill in the art having the benefit of this disclosure.

Rather than recycling plant waste into the ground as compost, the present invention creates streams to further breakdown plant waste into three basic components: cellulose fiber, protein, and mineral. Cellulose fiber can be used as a raw material for alcohol production. In addition, the paper industry is able to use the cellulose fiber as bedding material for dairy cow and chicken farms.

Proteins, oils, organic antibiotics, vitamins, minerals, and antioxidants are also able to be recovered as animal feed. The inorganic salts, that is rich in potassium and phosphoric, are able to be recycled back into the system along with water to irrigate the land.

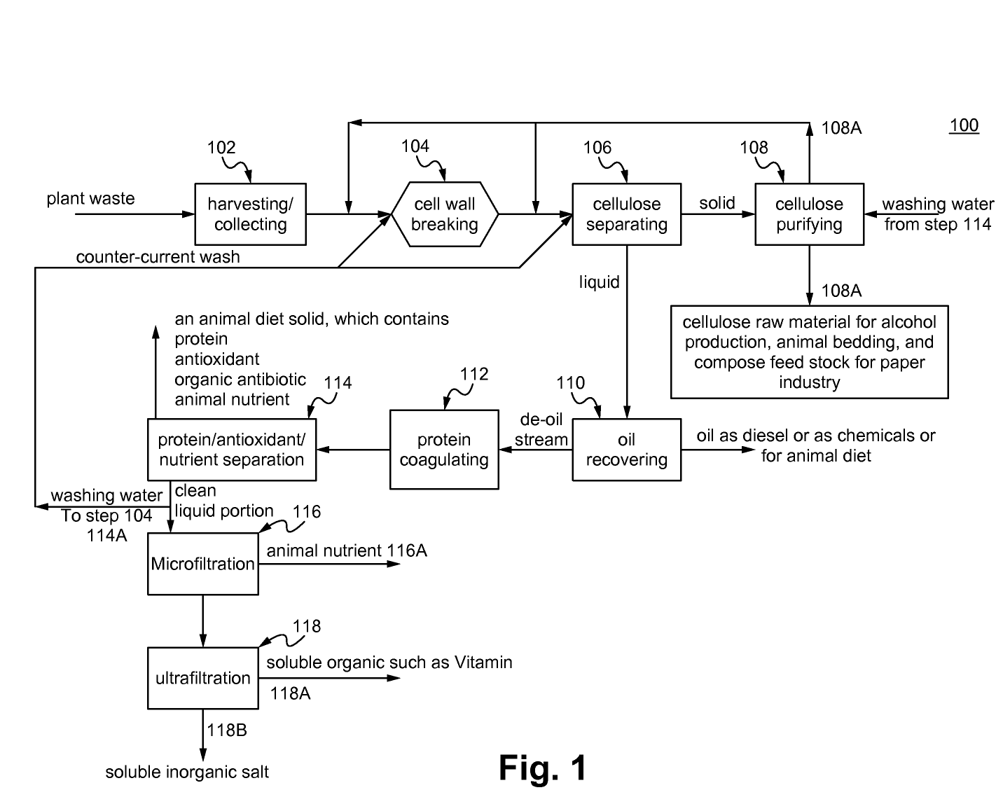

FIG. 1 illustrates a system 100 for converting agriculture waste in accordance with some embodiments of the present invention. The system 100 is able to separate all of the raw components and make uses of them. The system 100 is able to be used in an industrial or commercial scale plant.

At Step 102, agricultural waste (such as plant waste, including roots, skins, seeds, stalks, leaves) and stems are harvested and collected. A predetermined amount of water is added to the agriculture waste to have a 70 to 95% moisture content before feed to cell wall breaking device at Step 104. The water can be either fresh water or the water/fluid stream from the Step 108. At Step 104, the slurry is fed to a cell wall breaking device to break cell walls of the agriculture waste, such that protein, oil, starch/sugar, antioxidant, nutrient material, and mineral from cellulose cell wall (mainly fiber) are released. In some embodiments, the cell wall breaking device is a milling device, such as hammer mill, disc mill, pin mill, disintegrator, and simple blender type milling devices. A person of ordinary skill in the art appreciates that any other milling/grinding devices are able to be used so long as the milling device is able to break the cell walls. In some embodiments, one or more disc type grinding mills are used. At Step 106, cellulosic separation is performed. Cellulose (fiber) is removed from the grinded mass slurry, such that the cellulose is separated from valuable products, such as protein, oil, antioxidant, and nutrient. In some embodiments, the cellulosic separation uses a screen separation device, such as a pressure screen, a paddle screen, a vibration screen, a screen centrifuge, and a press. A person of ordinary skill in the art appreciates that any other separation devices that are able to separate cellulose are within the scope of the present invention. In some embodiments, a screw press is used after using a paddle screen to have a higher protein recovery and maximum cellulose (fiber) cake dryness.

At Step 108, the cellulose removed from the Step 106 is purified. The purification process is able to be performed by adding washing water to the cellulose. In some embodiments, the washing water is able to be from Step 114 as a counter current water wash. In some embodiments, the water/fluid stream from the Step 108 is able to be added to the cell wall breaking 104 or to the cellulose separating 106 as counter current wash. The above described counter current washing and/or additional paddle screen are able to generate purer fiber and recover more valuable products, such as protein, oil and antioxidant. The cellulose isolated from the cellulose purification step 108 is able to be collected at Step 108A as cellulose raw material, which is able to be used for alcohol production, animal feeding, and compose feed stock for paper industry. The fiber (cellulosic) is also able to be used as bedding material for dairy cow or chicken farm. With composting process, the cellulose is able to be used to produce organic fertilizer and soil condition materials. The cell wall that is broken by the grinding action speeds up the process of composting. The fiber is also able to be used as biodegradable oil absorber for oil spills, packing material, and other green technology.

At Step 110, oil recovering is able to be performed using the liquid from the cellulosic separation step 106. The liquid from cellulosic separation step 106 contains the entire valuable products, such as protein, oil, starch/sugar, antioxidant, nutrient, antibiotic, and hormone. When the agricultural waste used has very high oil content (such as orange peels), the oil recovering Step 110 is able to generate/recover significant amount of oil. At the Step 110, centrifuges such as decanter, desludger or disc decanter are able to be used. The oil recovered at the Step 110 is able to be used as fuel or for other industry usage. At Step 112, a de-oil stream from the oil recovering 110 is sent to the protein coagulating step 112, such that the protein is able to be coagulated by heating (temperature higher than 160° F.) or by adjusting the pH (around 5 or in an acidic condition). At the Step 112, oil, starch, antioxidant, nutrient, antibiotic, and hormones absorb and coagulate with protein. At Step 114, a separation step is performed. The coagulated proteins with all the valuable elements in the plant wastes from the Step 112 are able to be separated from the liquid by using a simple separation/filtration step/device, such that proteins with valuable ingredients are recovered, which is able to be an ideal animal feed. The animal feed is deemed organic with minimum or without antibiotics and hormone addition. A clean liquid with all the minerals from the separating/filtrating Step 114 is able to be used as animal drinking water or as plant irrigation water. The liquid portion from the separating Step 114 is able to be used as a washing water 114A to be used at the Step 104. At step 114, any liquid solid separation device (such as, bag filter, plate and frame filter, and drum filter) and centrifuges (decanter, basket, disc centrifuge and disc decanter) is able to be used.

At Step 116, a microfiltrating step is performed. The clean liquid from the Step 114 contains some soluble, valuable chemicals such as vitamins which can be further separated and recovered using a micron filtration device, such that animal nutrients are able to be isolated/recovered. At Step 118, ultra-filtrating process is able to be used, such that soluble organic substances 118A, such as vitamin, can be recovered, which are able to be used as an animal food. Soluble inorganic salt 118B from the ultrafiltrating Step 118 is able to be used as a plant food or inorganic chemicals.

In some embodiments, the cell wall breaking efficiency is able to be improved by applying heat, adjusting the pH value to around 8-10, or adding an enzyme or other chemicals before or during the cell wall breaking Step 104.

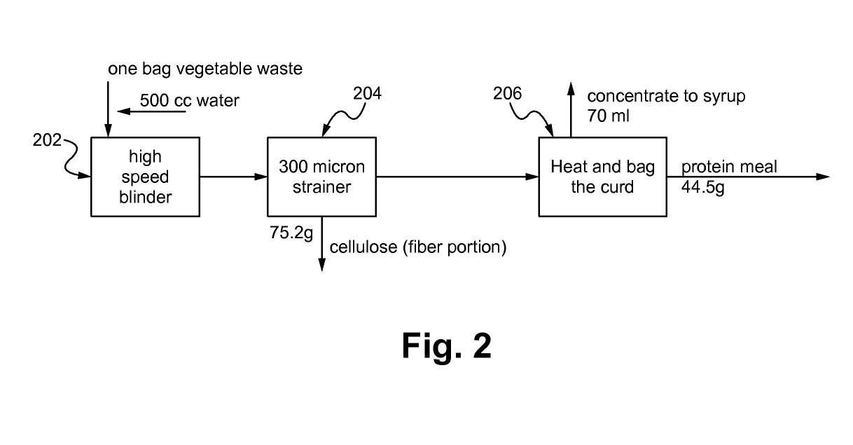

FIG. 2 illustrates a method of converting plant waste to useful animal feed in accordance with some embodiments of the present invention. At Step 202, 500 c.c. of water is mixed with a grocery shopping bag amount of Swiss chard (e.g., 600 g) in a 2,000 c.c. high speed kitchen blender. The bag of Swiss chard and water are grinded for 4 minutes. The grinded slurry is poured into a 300 micron kitchen strainer 204. The fiber portion is on the top portion/layer of the strainer. The grinded slurry is lightly pressed to remove as much liquid as possible. At Step 206, the liquid from the kitchen strainer 204 is collected and heated to around 180° F. The heating causes the proteins to coagulate and form a curd. This curd slurry was poured onto a cloth separating the curd from clean liquid. The curd was lightly pressed to produce a protein cake which contained all the antioxidants (green color) and nutrients. Both protein cake and fiber portion are sun dried. A person of ordinary skill in the art appreciates that any other drying processes are able to be used. After the drying process, the fiber portion and the protein portion are weighed and analyzed. The clean liquid from the Step 206 is dried (e.g., dried under sun) to remove most of the water producing a concentrated syrup, which is placed in a refrigerator overnight. The inorganic salt is crystallized out and settled in bottom. The weight of this syrup is analyzed.

The fiber, protein and syrup from one bag of Swiss chard is weighed and analyzed for protein, oil, starch, ash, nutrient and net energy, which is able to be used as animal feed. The analytic results of the components are shown in Table 1.

TABLE 1

| | | | | | Vegetable |
|---|---|---|---|---|---|
| | unit | Protein | Mineral | Fiber | Waste |
| weight produce | gram | 44.5 | 71 | 75.2 | % in dry |
| product | | | | | base |
| % moisture in product | % | 12.99 | 61.47 | 9.84 | |
| dry weight product | gram | 38.72 | 27.36 | 67.80 | 133.88 |
| % dry weight | % | 28.92 | 20.43 | 50.64 | |
| distribution | | | | | |
| protein (crude) | % | 35.7 | 10.1 | 10.3 | 17.60528 |
| Fat (crude) | % | 6.3 | 1.58 | 1.22 | 2.762793 |
| Fiber (acid detergent) | % | 22.3 | 0.01 | 22.3 | 17.74525 |
| ash | % | 10 | 34 | 12.8 | 16.32221 |
| Total digestible | % | 74.7 | 59.4 | 70.9 | |
| nutrients | | | | | |
| Net energy (lactation) | Mcal/Lbs. | 0.78 | 0.61 | 0.73 | |
| Net energy (maint) | Mcal/Lbs. | 0.79 | 0.59 | 0.74 | |
| Net energy (gain) | Mcal/Lbs. | 0.54 | 0.36 | 0.49 | |
| Digestible energy | Mcal/Lbs. | 1.49 | 1.19 | 1.42 | |
| Metabolizable energy | Mcal/Lbs. | 1.33 | 1.12 | 1.38 | |
| Starch (total) | % | 4.61 | 9.06 | 3.06 | |
| weight of protein | gram | 13.82 | 2.76 | 6.98 | 23.57 |
| weight of oil | gram | 2.44 | 0.43 | 0.83 | 3.70 |
| weight of fiber | gram | 8.63 | 0.00 | 15.12 | 23.76 |
| weight of starch | gram | 1.78 | 2.48 | 2.07 | 6.34 |
| weight of ash | gram | 3.87 | 9.30 | 8.68 | 21.85 |
| % protein distribution | % | 58.65 | 11.72 | 29.63 | 100.00 |
| % oil distribution | % | 65.95 | 11.69 | 22.36 | 100.00 |
| % fiber distribution | % | 36.35 | 0.01 | 63.64 | 100.00 |
| % starch distribution | % | 28.16 | 39.10 | 32.73 | 100.00 |
| % ash distribution | % | 17.72 | 42.57 | 39.72 | 100.00 |

The data show that the protein portion (e.g., the solid portion from the Step 114) has 35.7% protein, 6.3% oil and 22% fiber, which is ideal to be used as a chicken diet or pig diet. The combination of the cell breaking process and the protein recovering process is able to produce a protein meal as animal feed. The protein meal is able to have 58.65% protein recovery, 65.95% oil recovery, and only containing 36.36% of total fiber in the plant waste. These fine fibers produced using an embodiment of the present invention are finer and semicellulose, which are able to be consumed and easily converted to energy by chickens and pigs. This protein product has 1.49 Kcal/lb. of digestible energy and 1.33 Kcal/lb. of metabolized energy.

In the following Table 2 shows a composition table of some selected agriculture wastes that is able to be used in accordance with some embodiments of the present invention.

TABLE 2
Composition of agriculture wastes

| | | | | | Nitrogen- | | |
|---|---|---|---|---|---|---|---|
| | Crude | Crude | Ether | Ash | free | Crude | Crude |
| | protein | fiber | extract | content | extract | fat | ash |
| Vegetable leave | 14.85% | 18.21% | | 15.21% | | | |
| waste | | | | | | | |
| Straw | 3.25% | 44.30% | 0.85% | 20.75% | 30.85% | | |
| Husk rice bran | 15.50% | 8.50% | 1% | 8% | | | |
| Corn stalk | 6.20% | 23.40% | | | 62.90% | 2.30% | 5.30% |
| Corn cobs | 4.20% | 23.80% | | | 67.40% | 2.80% | 1.80% |
| Soybean vine | 11.50% | 22.31% | | | | | |
| Wheat bran | 14.10% | 10.10% | | | | 3.90% | |
| Sugar cane | 4.50% | | | | | | |
| leaves | | | | | | | |

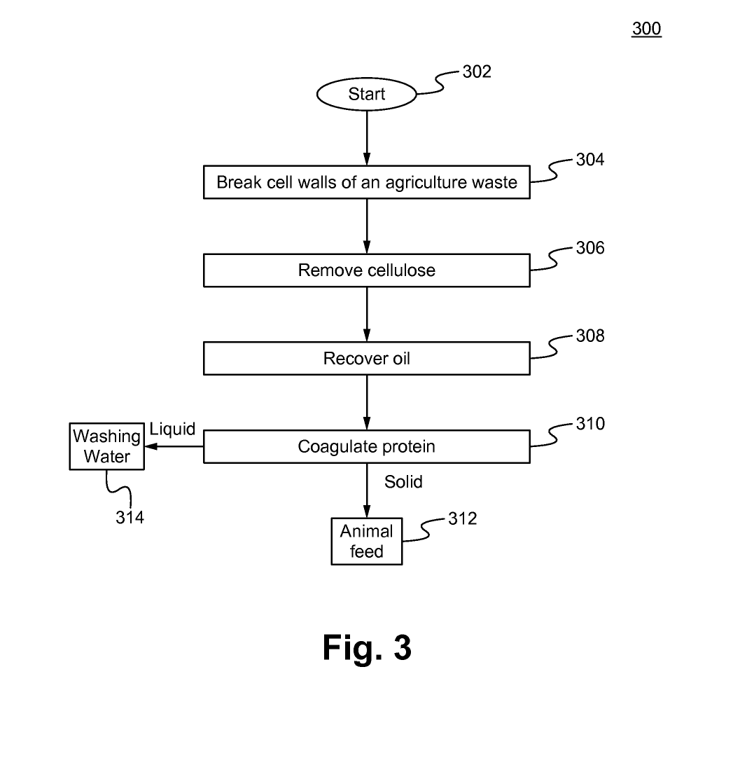

FIG. 3 illustrates a method 300 of converting agriculture wastes to animal feed in accordance with some embodiments of the present invention. The method 300 is able to start at Step 302. At Step 304, cell walls of an agriculture waste in a slurry form are broken. At Step 306, cellulose is removed from the slurry. At Step 308, oil is recovered. At Step 310, proteins are coagulated. The liquid portion from the Step 310 is able to be used as washing water at Step 314. The solid portion from the Step 310 is able to be used as animal feed at Step 312.

Artificial antibiotics are heavily used in animal diet, which becomes a serious health issue for humans that consume these animals. Solutions to the issue stated above are needed. Plants, vegetables, and fruits possess high sources of vitamins and minerals which are ideal sources for making free of artificial antibiotic animal feed. The animal feed produced by the process and system in accordance with some embodiments is rich in fine/soluble fiber, proteins, hydrocarbon, oils, organic antibiotics minerals, and antioxidants, which is ideal for pure organic diet for animals.

To utilize the agriculture waste, nutrients (proteins, oils, hydrocarbons, antioxidants, organic antibiotics, minerals, and vitamins) are extracted from discarded plant wastes (roots, skins, seeds, stalks, leaves, and stems) using grinding and separation processes, such that the normally discarded agriculture waste is able to be converted into useful products.

In operation, the wastes are collected, the cell walls of the plant wastes are broken to release the proteins and nutrients along with other useful components. The proteins are coagulated to be isolated with useful nutrients and minerals to make an ideal animal feed.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims.

1. A method of making animal feed comprising:
a. collecting an agriculture substance;
b. breaking cell walls of the agriculture substance;
c. removing a cellulose substance; and
d. forming food having a content suitable for animal consumption.

2. The method of claim 1 further comprising recovering oil.

3. The method of claim 1 further comprising coagulating protein.

4. The method of claim 3, wherein the coagulating protein comprises heating to a temperature higher than 160° F.

5. The method of claim 3, wherein the coagulating protein comprises adjusting a pH value to be in the range between 3-6.

6. The method of claim 1, wherein the agriculture substance comprises a plant waste.

7. The method of claim 6, wherein the plant waste comprises roots, skins, seed, stalks, leaves, or a combination thereof.

8. The method of claim 1 further comprising making a slurry by adding water to the agriculture substance.

9. The method of claim 1, wherein the slurry has a moisture content of 70%-90%.

10. The method of claim 1 further comprising releasing protein, oil, starch, antioxident, nutrient, or a combination thereof by the breaking cell walls.

11. The method of claim 1, wherein the breaking cell walls is performed by using a milling device.

12. The method of claim 1, wherein the milling device comprises a hammer mill, a disc mill, a pin mill, a disintegrator, a simple blender type mill, or a combination thereof.

13. The method of claim 1, wherein the removing a cellulose substance comprises using a cellulose washing or removing device, wherein the cellulose washing or removing device comprises a paddle screen, a vibration screen, a screen centrifuge, a screw press, or a combination thereof.

14. The method of claim 1 further comprising increasing a yield of protein recovery by using a solid/liquid separation device, wherein the solid/liquid separation device comprises a plate and frame filter, a drum filter, a solid/liquid centrifuge separator, a belt press, or a screw press.

15. The method of claim 1 further comprising adding an enzyme or chemical at the breaking cell walls.

16. The method of claim 1, wherein the food comprises protein, hydrocarbon, antioxidant, organic antibiotic, mineral, and vitamin.

17. The method of claim 1 further comprising forming animal drinking water containing minerals and substantially free of protein.

18. The method of claim 1, wherein the cellulose substance is treated to produce a raw material for paper industry, alcohol, animal bedding, compose, organic fertilizer, or organic packing material.

19-22. (canceled)

23. A method of converting agriculture waste comprising:
a) gathering an amount of agriculture waste;
b) breaking cell walls of the agriculture waste in a slurry using a milling device, such that proteins, hydrocarbons, antioxidants, organic antibiotics, minerals, and vitamins are released;
c) removing cellulose from the slurry using a screen separating device;
d) coagulating the proteins; and
e) forming an animal food.

24. The method of claim 23, further comprising mixing an amount of water with the agriculture waste to form the slurry.
